(19) United States
(12) Patent Application Publication
(10) Pub. No.: US 2011/0002548 A1
(43) Pub. Date: Jan. 6, 2011

(54) SYSTEMS AND METHODS OF VIDEO NAVIGATION

(75) Inventors: Balaji Badhey Sivakumar, Madural (IN); Abdul Raheem, Madurai (IN); Jayaprakash Chandrasekaran, Madurai (IN); Sachin J, Kannur (IN)

Correspondence Address: HONEYWELL/HUSCH;Patent Services, 101 Columbia Road, P.O.Box 2245, Morrlstown, NJ, 07962, US

(73) Assignee: Honeywell International Inc., Morristown, NJ (US)

(21) Appl. No.: 12/497,020

(22) Filed: Jul. 2, 2009

(51) Int. Cl. G06K 9/48; H04N 7/18

(52) U.S. Cl. 382/199; 348/159; 348/E07.085

(57) ABSTRACT

A system and method of tracking an object as it navigates through a monitored region is provided. The method includes displaying at least a first video data stream associated with at least a first data collection device monitoring a first region, selecting a linked area of the first video data stream, and displaying at least a second video data stream associated with a second data collection device. The linked area is associated with at least a second data collection device monitoring the second region, and the data collection devices can include PTZ cameras. In some embodiments, the method includes comparing the selected linked area with a stored predefined area using an image recognition algorithm.

### FIELD OF INVENTION

The present invention relates generally to video surveillance. More particularly, the present invention relates to systems and methods of tracking an object as it travels through a monitored region.

### BACKGROUND

Video surveillance is an integral part of the technology used in modern day security systems. Known security systems can include surveillance cameras, video recorders, and video viewers so that surveillance cameras or other data collection devices monitor a particular region. Video data streams from the cameras can be displayed and monitored by security personnel on video viewers or monitors, and the video can be stored in associated video recorders or other data storage devices.

In known video surveillance systems, multiple surveillance cameras or other data collection devices can be used to monitor a particular location. For example, one surveillance camera can be used to monitor an entryway to a particular building. Other surveillance cameras can be used to monitor each room in the building, and still another surveillance camera can be used to monitor the exit door of the building. In some systems, multiple surveillance cameras can be located in a single room.

To monitor a particular region, security personnel must continuously monitor video data streams captured by surveillance cameras and displayed on video viewers. When multiple surveillance cameras are used to monitor a region or premise, security personnel must monitor, view, and navigate between the video data streams from the different cameras. When an object in the monitored region moves from an area captured by one surveillance camera to an area captured by a second surveillance camera, security personnel must navigate from viewing the video data stream captured by the first camera to viewing video data stream captured by the second camera.

In known systems and methods of video surveillance, security personnel can navigate between video data streams associated with different surveillance cameras by selecting the camera name associated with the desired video data stream. Additionally or alternatively, security personnel can select a nearby preconfigured camera associated with the desired video data stream. Security personnel can also select a predefined set of cameras that monitor a particular region or area to view video data streams associated with those cameras.

However, the time, expense, and personnel training associated with these known systems and methods of video navigation have lead many users to desire improved systems and methods of video navigation. In known systems and methods, security personnel must know and remember, on command, surveillance camera names and locations preconfigured to monitor a particular region. Furthermore, security personnel must be able to quickly and accurately navigate between video data streams associated with various cameras as an object moves between areas covered by the cameras.

Accordingly, there is a continuing, ongoing need for improved systems and methods of tracking an object as it navigates through a monitored region. Preferably, such systems and methods intelligently navigate between video data streams associated with different surveillance cameras monitoring a region.

### BRIEF DESCRIPTION OF THE DRAWINGS

FIG. 1 is a flow diagram of a method of navigating between video data streams associated with different data collection devices monitoring a region in accordance with the present invention;

FIG. 2 is a block diagram of a system for carrying out the method of FIG. 1 in accordance with the present invention;

FIG. 2A is a block diagram of an installed system in accordance with the present invention

FIG. 3 is an interactive window displayed on a viewing screen of a graphical user interface for creating a set of cameras to monitor a predefined region in accordance with the present invention;

FIG. 4 is an interactive window displayed on a viewing screen of a graphical user interface for creating a virtually linked area in accordance with the present invention;

FIG. 5 is an interactive window displayed on a viewing screen of a graphical user interface for selecting a set of cameras to be associated with a virtually linked area in accordance with the present invention;

FIG. 6 is an interactive window displayed on a viewing screen of a graphical user interface for displaying a virtually linked area in accordance with the present invention; and

FIG. 7 is an interactive window displayed on a viewing screen of a graphical user interface for displaying video data streams from a set of cameras associated with a virtually linked area.

### DESCRIPTION OF THE PREFERRED EMBODIMENTS

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments of the present invention include improved systems and methods of tracking an object as it navigates through a monitored region. Preferably, such systems and methods intelligently navigate between video data streams associated with different surveillance cameras monitoring a region. In embodiments of the present invention, an operator or user can navigate between video data streams from surveillance cameras monitoring a region. The user can between switch between viewing video from cameras that are physically or logically related, for example, cameras that are in adjacent rooms.

In accordance with systems and methods of the present invention, navigation between video data streams associated with monitored regions can be faster and more intuitive than known systems and methods. Furthermore, security personnel or operators can more easily navigate between video data streams.

Systems and methods of the present invention can reduce operator response time when monitoring surveillance video and assist operators tracking objects moving through various regions. Further, systems and methods of the present invention can reduce the training time required for operators learning to navigate between video data streams.

In accordance with the present invention, a camera or set of cameras can be associated with a predefined area, region, or zone. When the predefined area is selected on a video data stream of the area, video data streams associated with the predefined area can be displayed to a user.

For example, a virtually linked area can be created via live video data streams so that a preconfigured camera or set of cameras is associated with the virtually linked area. When an operator selects the virtually linked area, the video data streams associated with the preconfigured camera or set of cameras are displayed to the operator. Accordingly, in systems and methods of the present invention, an operator need not know the names or locations of surveillance cameras in a security system, and an operator need not manually open a camera or set or cameras associated with a particular region or area.

In embodiments of the present invention, virtually linked areas can be regions of interest in a monitored region. For example, if the monitored region is a room, and the room has a door, a region of interest can be the door. An operator can select the door to be a virtually linked area and associate the virtually linked area (the door) with a camera or set of cameras that monitors that area on the opposite side of the door. Accordingly, when the operator selects the virtually linked area (the door), video data streams associated with cameras monitoring the area on the opposite side of the door are displayed.

In some embodiments, a set of surveillance cameras can monitor a preconfigured region. When video data streams associated with all of the cameras in the set are displayed, an operator can monitor the whole preconfigured region. A virtually linked area can be associated with a set of surveillance cameras so that when an operator selects the virtually linked area, an integrated display of the video data streams associated with the cameras in the set are displayed. Accordingly, an operator is presented with a full view of the preconfigured region by selecting only the one virtually linked area instead of individual cameras or regions.

Pan Tilt Zoom (PTZ) cameras known by those of ordinary skill in the art can be incorporated into systems and methods of the present invention. When PTZ cameras are employed, image recognition techniques known by those of ordinary skill in the art can also be employed to locate virtually linked areas. For example, a virtually linked area can be associated with an image of object and background. The image of the object and background can be stored for later recognition.

A PTZ camera can monitor a particular region and provide video data streams of that region to an operator for viewing on a monitor, for example. When a user selects an area of the monitored region, the selected area can be compared to the stored object and background associated with the virtually linked area using, for example, a principal component analysis (PCA) image recognition algorithm. When the selected area matches the stored object and background according to the image recognition algorithm, video data streams of cameras associated with the virtually linked area can be displayed to the operator.

In some embodiments, systems and methods of the present invention can use image recognition techniques known by those of skill in the art to associate cameras with a particular area even when the cameras are moved or shifted. In other embodiments, a PTZ camera can readjust to a required position so as to focus on a particular object or region in accordance with preconfigured regions.

In some embodiments, a pop up window, for example, displaying video from cameras associated with a particular area can be displayed to an operator when the operator moves a cursor or mouse over the area. In this manner, the operator can readily and simultaneously view video data streams from cameras associated with both first and second regions.

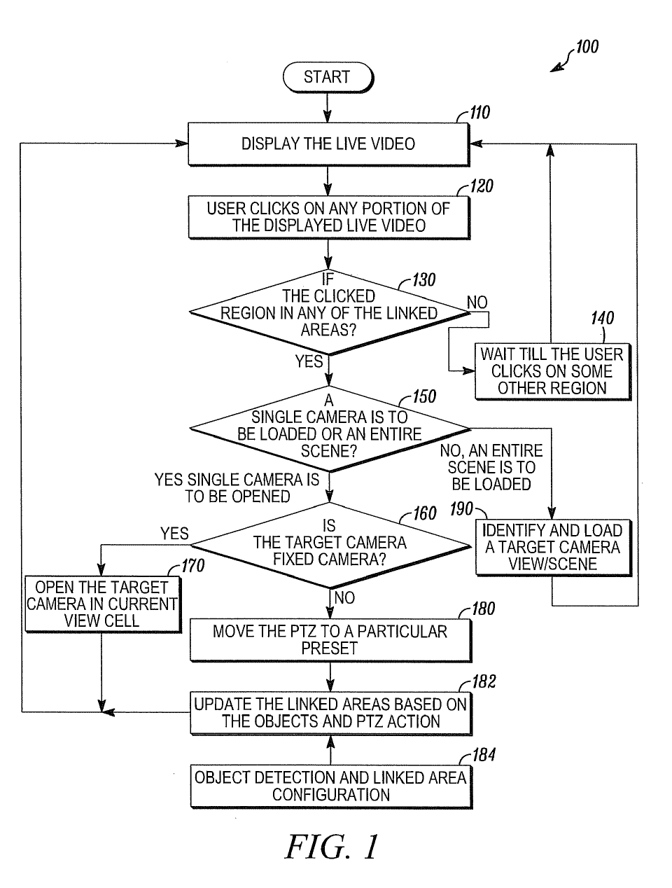

FIG. 1 is a flow diagram of an exemplary method 100 of navigating between video data streams associated with different data collection devices monitoring a region in accordance with the present invention. In the method 100, live video data streams can be displayed to an operator or user as in 110. Then, a user can select any region of the displayed video by, for example, selecting or clicking on that portion of the displayed video as in 120.

The method 100 determines if the selected region corresponds to any virtually linked area of the monitored region as in 130. If the selected region does not correspond to a virtually linked area, then the method 100 waits until a user selects a different region as in 140 and continues to display live video data streams as in 110. However, if the selected region does correspond to a virtually linked area, then the method 100 determines whether a single camera or a set of cameras is associated with the selected virtually linked area as in 150.

If a single camera is associated with the selected virtually linked area, then the method 100 determines if that camera is a fixed camera or a PTZ camera is in 160. If the camera is a fixed camera, then the method 100 selects the video data stream associated with that camera as in 170 and displays that video data stream as in 110.

However, if a PTZ camera is associated with the selected virtually linked area, the PTZ camera is moved to a preconfigured position as in 180. The virtually linked area is updated as in 182 based on the object associated with the virtually linked area (184) and the movement of the PTZ camera (180).

If the method 100 determines that a set of cameras is associated with the selected virtually linked area as in 150, then the method 100 identifies the preconfigured set of cameras and displays video data streams associated with the those cameras as in 190.

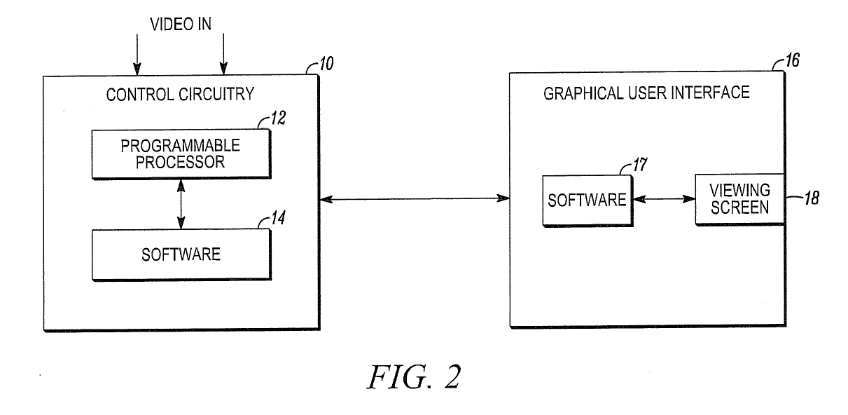

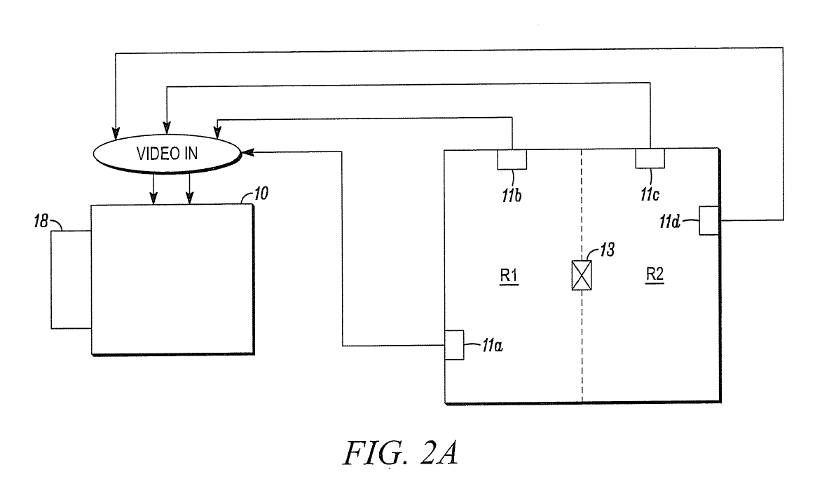

The method shown in FIG. 1 and others in accordance with the present invention can be implemented with a programmable processor and associated control circuitry. As seen in FIG. 2, control circuitry 10 can include a programmable processor 12 and software 14, stored on a local computer readable medium, as would be understood by those of ordinary skill in the art. Video from a plurality of cameras, recorders, or other data collection or storage devices can be input into the programmable processor and associated control circuitry.

An associated user interface 16 can be in communication with the processor and associated circuitry 10. A viewing screen 18 of the user interface, as would be known by those of skill in the art, can display interactive and viewing windows. In embodiments of the present invention, the user interface 16 can be a multi-dimensional graphical user interface.

FIG. 2A is a block diagram of an installed system in accordance with the present invention. As seen in FIG. 2A, a plurality of surveillance cameras, for example, 11a and 11b, can be installed in and monitor a region R1. A plurality of surveillance cameras, for example, 11c and 11d, can be installed in and monitor a region R2. Video data streams from the cameras 11a, 11b, 11c, and 11d can be input into control circuitry 10 and displayed on the associated viewing screen 18.

In embodiments of the present invention, video data streams from the cameras 11a and 11b in the first region R1 can be displayed on the viewing screen. A door 13 that provides access from first region R1 to the second region R2 can be a virtually linked area, and cameras 11c and 11d located in the second area R2 can be associated with the virtually linked area (the door 13). Accordingly, when video data streams from the cameras 11a and 11b are displayed on the viewing screen 18, a user can select the door 13 as displayed on the viewing screen 18. When the virtually linked area (the door 13) is selected, video data streams from the cameras 11c and 11d in the second region R2 will be displayed on the viewing screen 18. In this manner, a user can easily and efficiently navigate between video associated with separate monitored regions.

The interactive and viewing windows shown and described herein are exemplary only. Those of skill in the art will understand that the features of the windows shown and described herein may be displayed by additional or alternate windows.

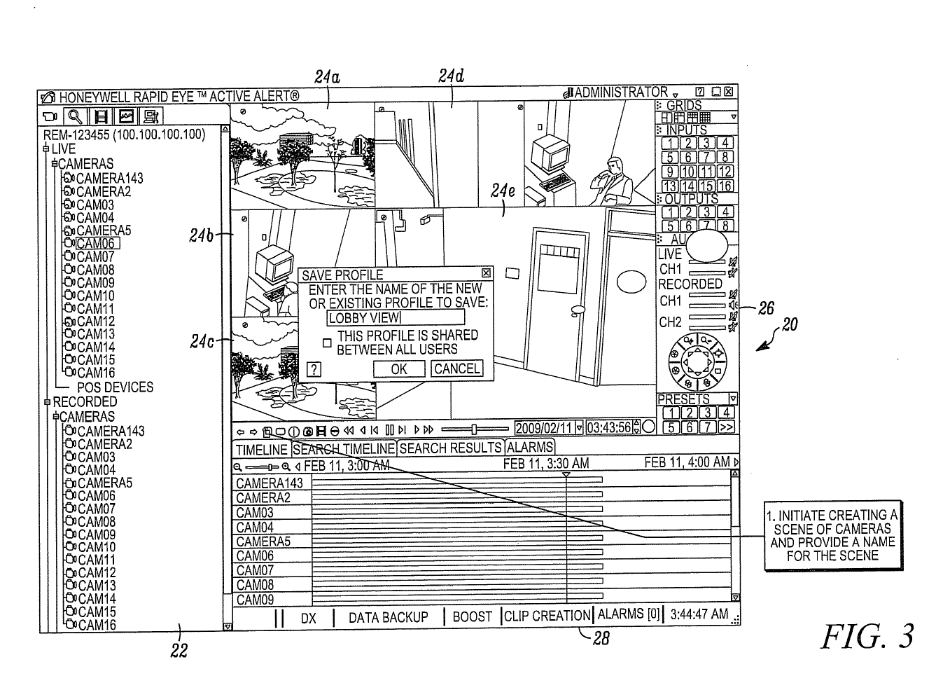

FIG. 3 is an interactive window displayed on a viewing screen 20 of a graphical user interface for creating a set of cameras to monitor a predefined region in accordance with the present invention. The names of various cameras, recorders, or other data collection or storage devices (live or pre-recorded) associated with the system of the present invention can be displayed in a left pane 22 of the window. The camera names can be organized by their location, alphabetically, or numerically, for example, for ease of reference.

When a camera is selected, a video data stream from that camera can be displayed in a sub-window 24a, 24b, 24c, 24d, or 24e in a right pane 26 of the window 20. Timelines corresponding to the cameras can be displayed in a bottom pane 28 of the window 20.

To create a set of cameras for monitoring a predefined region, a user can select the cameras to be part of the set. Video data streams associated with the selected cameras can be displayed in the sub-windows 24a, 24b, 24c, 24d, and 24e, and a user can select a naming icon of the window 20 to name the scene of the predefined region monitored by the selected cameras.

For example, in FIG. 3, the sub-windows, 24a, 24b, 24c, 24d, and 24e display video data streams associated with cameras monitoring a lobby region. These cameras can be associated with a predefined set of cameras, and the scene can be named “Lobby View.”

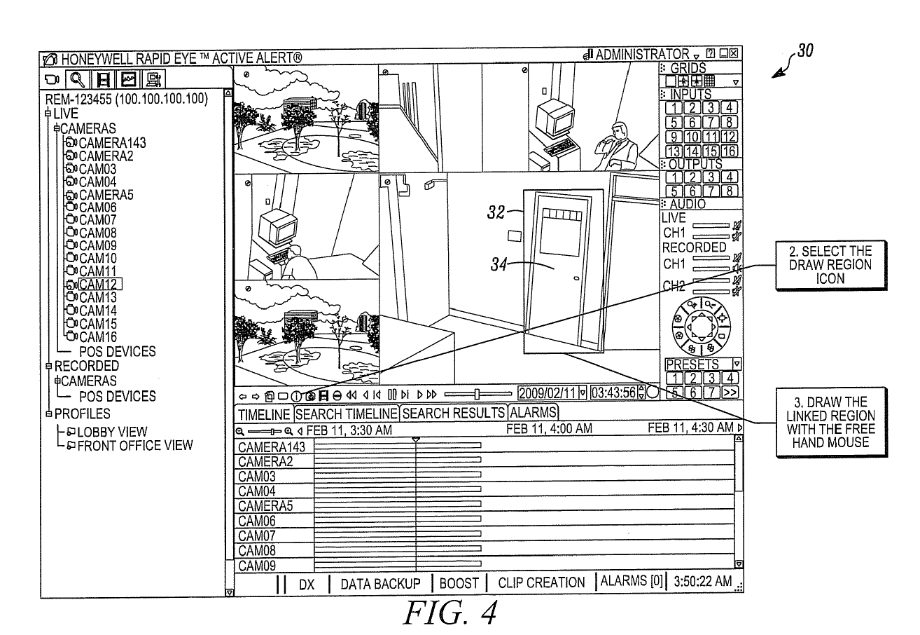

FIG. 4 is an interactive window displayed on a viewing screen 30 of a graphical user interface for creating a virtually linked area in accordance with the present invention. A user can select a drawing icon of the window 30 to draw a virtually linked area. Then, a user can use a mouse or other selection apparatus to draw boundaries that define the edges of a virtually linked area. For example, in FIG. 4, a user can draw boundaries of a virtually linked area around the lobby door so that the door is a virtually linked area.

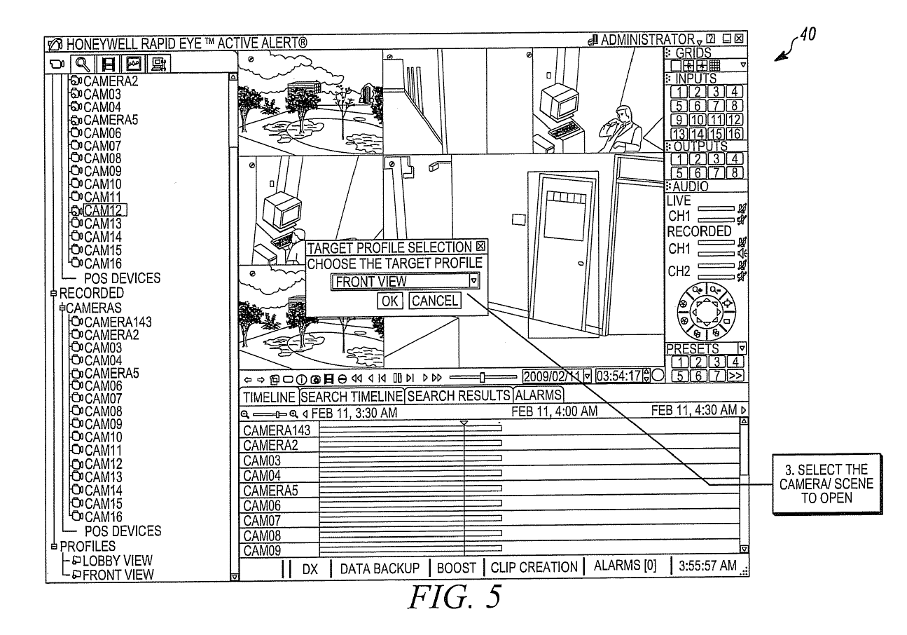

FIG. 5 is an interactive window displayed on a viewing screen 40 of a graphical user interface for selecting a set of cameras to be associated with a virtually linked area in accordance with the present invention. After defining a virtually linked area as shown in FIG. 4 (the door), a user can select a scene, predefined set of cameras, or individual camera to be associated with the virtually linked area. Video data streams associated with the predefined set of cameras, the individual camera, or cameras associated with the selected scene will be displayed when a user selects the virtually linked area by, for example, clicking a mouse or cursor within the boundaries defining the virtually linked area.

For example, in FIG. 5, a user can select a “Front View” to be associated with the virtually linked area (the door). The “Front View” can be associated with a set of cameras monitoring the region outside of the door and the front of the building.

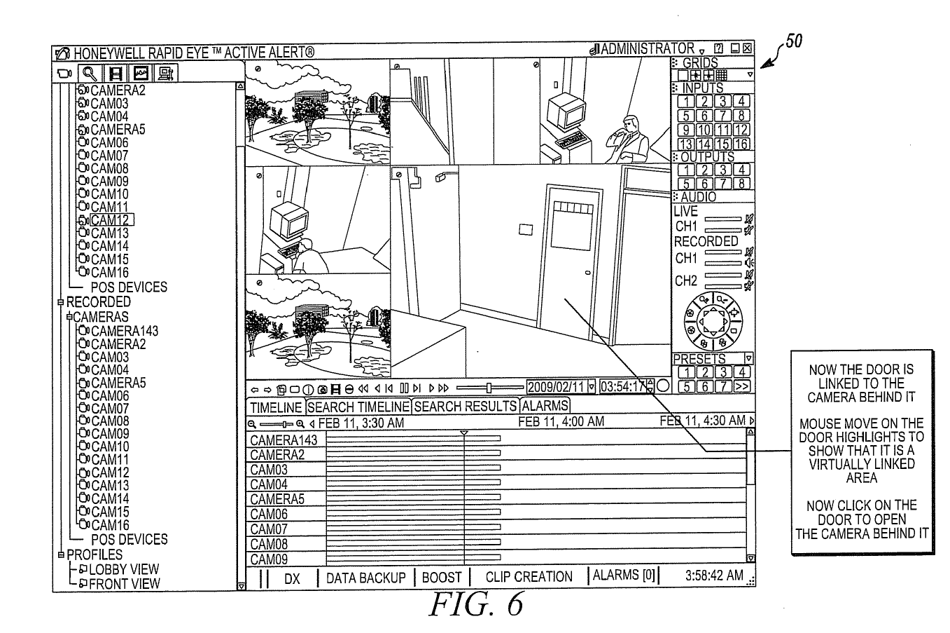

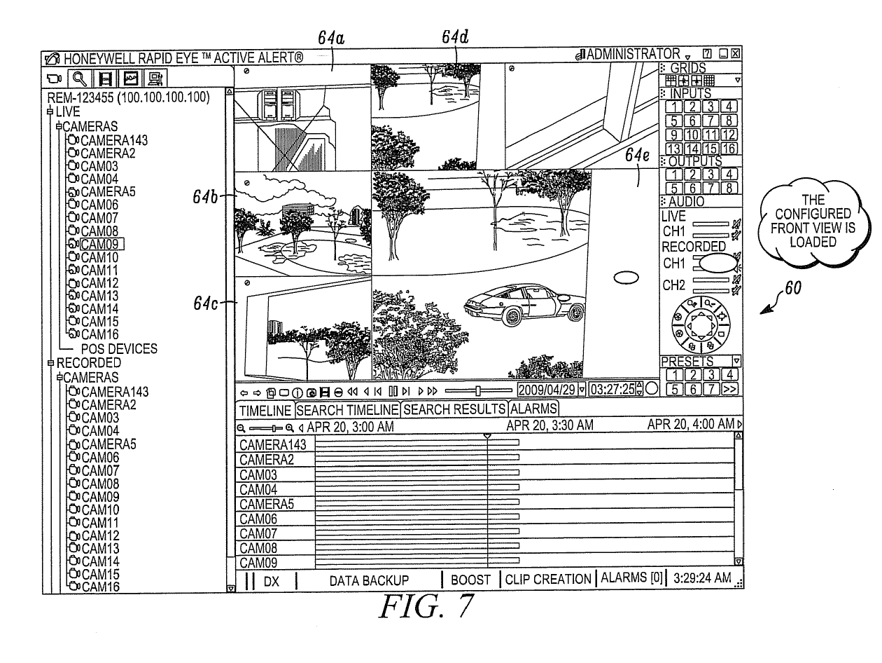

FIG. 6 is an interactive window displayed on a viewing screen 50 of a graphical user interface for displaying a virtually linked area in accordance with the present invention. When a mouse or other cursor is positioned over the virtually linked area, the virtually linked area is highlighted to alert a user that the area is virtually linked. When a user selects or clicks the virtually linked area (the door), video data stream(s) associated with the “Front View” can be displayed as shown in FIG. 7. For example, video data streams associated with the “Front View” cameras can be displayed in sub-windows 64a, 64b, 64c, 64d, and 64e of the window 60.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the sprit and scope of the claims.

What is claimed is:

1. A method comprising:
displaying at least a first video data stream associated with at least a first data collection device monitoring a first region;
selecting a linked area of the first video data stream, the linked area is associated with at least a second data collection device monitoring a second region; and
displaying at least a second video data stream associated with the second data collection device.

2. The method of claim 1 wherein displaying the first video data stream includes providing a plurality of data collection devices monitoring the first region.

3. The method of claim 2 wherein displaying the first video data stream includes displaying video data streams associated with the plurality of data collection devices monitoring the first region.

4. The method of claim 1 wherein displaying the second video data stream includes providing a plurality of data collection devices monitoring the second region.

5. The method of claim 4 wherein displaying the second video data stream includes displaying video data streams associated with the plurality of data collection devices monitoring the second region.

6. The method of claim 1 wherein at least one of the first or second data collection devices includes a camera.

7. The method of claim 1 wherein the second data collection device includes a PTZ camera.

8. The method of claim 7 further comprising adjusting the PTZ camera to a predefined position before displaying the second video data stream.

9. The method of claim 1 wherein displaying the first video data stream occurs in real-time.

10. The method of claim 1 wherein displaying the second video data stream occurs in real-time.

11. The method of claim 1 further comprising comparing the selected linked area with a stored predefined area.

12. The method of claim 11 wherein comparing the selected linked area with the stored predefined area uses an image recognition algorithm.

13. A method comprising:
displaying at least a first video data stream associated with at least a first data collection device monitoring a first region;
defining boundaries of a linked area in the first video data stream;
associating at least a second data collection device monitoring a second region with the linked area.

14. The method of claim 13 wherein associating the second data collection device includes providing a plurality of data collection devices monitoring the second region.

15. An interactive viewing apparatus comprising:
means for displaying at least a first video data stream associated with at least a first data collection device monitoring a first region;
means for selecting a linked area of the first video data stream, the linked area is associated with at least a second data collection device monitoring a second region; and
means for displaying at least a second video data stream associated with the second data collection device.

16. The interactive viewing apparatus of claim 15 further comprising means for defining boundaries of the linked area and means for associating the second data collection device with the linked area.

17. The interactive viewing apparatus of claim 15 further comprising means for indicating to a user that an area is the linked area.

18. The interactive viewing apparatus of claim 15 wherein the means for displaying the first video data stream includes means for providing a plurality of data collection devices monitoring the first region.

19. The interactive viewing apparatus of claim 15 wherein the means for displaying the second video data stream includes means for providing a plurality of data collection devices monitoring the second region.

20. The interactive viewing apparatus of claim 15 wherein at least one of the first or second data collection devices includes a PTZ camera.
